(19) United States
(12) Patent Application Publication
(10) Pub. No.: US 2020/0074358 A1
(43) Pub. Date: Mar. 5, 2020

(54) REVERSE CONSTRUCTION PROJECT AUCTION SYSTEM AND METHOD

(71) Applicant: Dallas Raymond Nugent, Dallas, TX (US)

(72) Inventor: Dallas Raymond Nugent, Dallas, TX (US)

(21) Appl. No.: 16/413,041

(22) Filed: May 15, 2019

Related U.S. Application Data
(63) Continuation-in-part of application No. 16/021,817, filed on Jun. 28, 2018.

(51) Int. Cl. G06Q 10/06; G06Q 50/08; G06Q 40/04; G06Q 10/10; G06Q 30/08

(52) U.S. Cl. CPC G06Q 10/06; G06Q 50/08; G06Q 30/08; G06Q 10/103; G06Q 40/04

(57) ABSTRACT

A construction project management method includes receiving a proof of project document associated with a project for a general contractor, the proof of project document having one or more details of the project contained therein and being verification of the general contractor having been awarded the project; receiving details about the project from the general contractor; posting the details about the project to an online platform accessible by subcontractors via computing devices; receiving a base quote for a job associated with the project, the base quote being determined by the general contractor and the base quote being a lowest price the general contractor is willing to pay for completion of the job; posting the base quote for the job on the online platform for acceptance by one of the subcontractors; and creating a contract associated with the job between the general contractor and one or more subcontractors.

### BACKGROUND

### 1. Field of the Invention

The present invention relates generally to project bid systems, such as are common in contract projects, and more specifically, to a construction project system and method for collecting bids from subcontractors for general contractors already hired for a project, thereby eliminating the uncertainty associated with subcontractor bidding as is common in the art.

### 2. Description of Related Art

Project bidding systems and methods are well known in the art and are effective means for project owners to hire general contractors and general contractors to hire subcontractors. For example, FIG. 1 depicts a flowchart 101 of a general bid method, wherein a project owner gives out details of a project to general contractors, as shown with box 103. The general contractors then share details with subcontractors to collect a plurality of bids therefrom, as shown with box 105. Based on the subcontractor bids, the general contractor then inputs a bid to the project owner, as shown with box 107. The project owner then hires a general contractor based on bids received, as shown with box 109.

One of the problems commonly associated with method 101 is inaccurate bidding and uncertainty. For example, subcontractors receive many opportunities to bid on jobs, and do not always put in the time and effort to ensure that they are making an accurate bid. This is due to the fact that for their bid to be accepted, they have to beat all other subcontractors, and then also the general contractor that they are bidding on must win the project. Alternatively, the subcontractor may have to input bids with a plurality of general contractors in order to increase their odds of being hired for a job, thereby being inefficient.

Accordingly, although great strides have been made in the area of project bidding systems and methods, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common project bidding method;

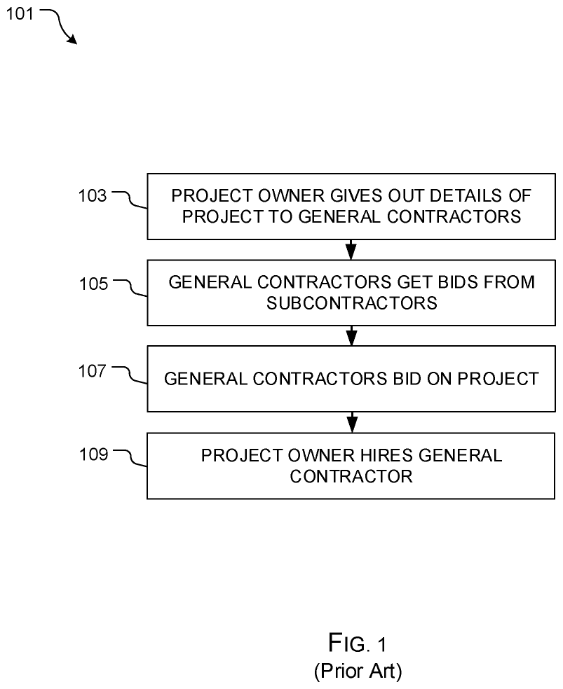

FIG. 2 is a simplified diagram of a reverse construction project auction system in accordance with a preferred embodiment of the present application;

FIG. 3 is a simplified diagram of a reverse auction platform of FIG. 2;

FIG. 4 is a simplified diagram of the features of a subcontractor portal of FIG. 2;

and

FIG. 5 is a flowchart of the method of use of the system of FIG. 2.

FIG. 6 is a diagram of the method of use of a reverse auction platform of FIG. 2.

FIG. 7 is a simplified diagram of the method of use of reverse auction platform of FIG. 2.

FIG. 8 is a diagram of the method of use of a subcontractor portal of FIG. 2.

FIG. 9 is a flowchart of the method of use of a subcontractor portal of FIG. 2

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional project bid systems. Specifically, the present invention provides for improved information sharing between the parties, as well as for increase efficiency for the subcontractors who are bidding on jobs already awarded or proposed to a general contractor. In addition, the present invention provides a means for contract creation between the parties. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

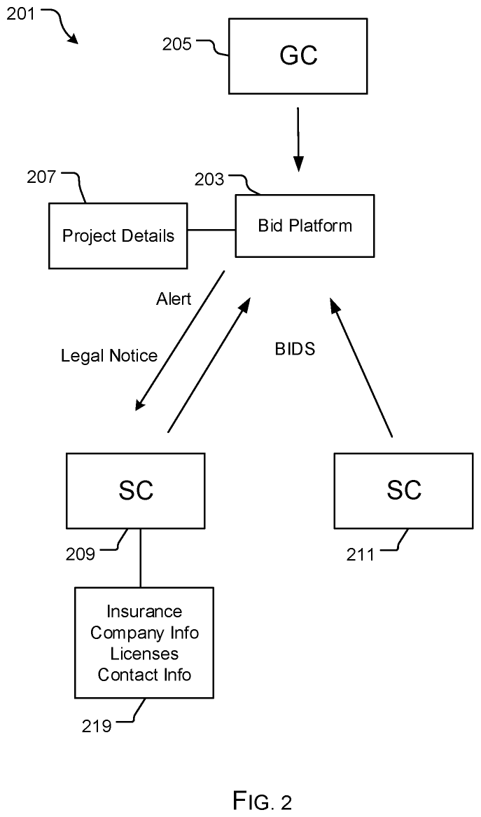

Referring now to the drawings wherein like reference characters identify corresponding or similar elements throughout the several views, FIG. 2 depicts a diagram of a reverse construction project auction system 201 in accordance with a preferred embodiment of the present application. It will be appreciated that system 201 overcomes one or more of the above-listed problems commonly associated with conventional project bidding systems.

In the contemplated embodiment, system 201 includes a bid platform 203 configured to receive project details 207 from a general contractor 205, wherein the project details 205 are sufficient for subcontractors 209, 211 to accurately bid on the project. It should be understood that the GC 205 has responsibility for the project by a project owner/manager, and therefore, the SCs 209, 211 only have to bid with the particular GC in order for a chance to win the work. It should be appreciated that each bid drives the price of the work down, thereby providing the means for the general contractor to save money and work with the most efficiently priced subcontractor.

It will be understood that the CG 205, SCs 209, 211 and any other entity using the system 201 could have profiles associated therewith including data to identify the respective entity.

During the bidding process, each SC 209, 211 can receive alerts when their last bid is outbid, thereby providing the desired information for an SC to continually lower their own bid, driving the cost further down. It is contemplated that each bid can be verified, such as through a verified statement of a relevant party.

In some embodiments, it is contemplated that the subcontractors 209, 211 must provide verifying and important details 219, such as insurance information, contact information, company information, and relevant licenses, thereby again providing the general contractor 205 with relevant details to make a decision.

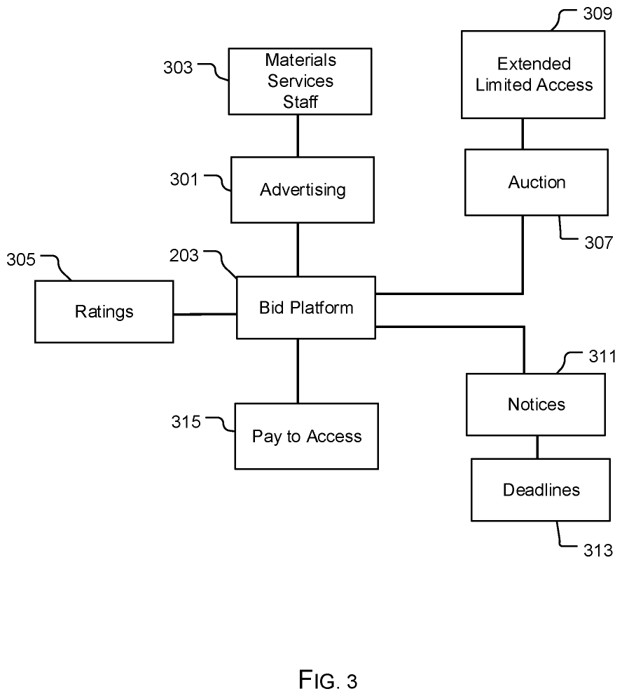

In FIG. 3, a diagram depicts additional features of platform 203, including an advertising means 301, wherein a variety of advertisements 303 created by general contractors, subcontractors, suppliers, service providers, etc., can be created and displayed, thereby providing a means for general contractors and subcontractors to hire staff, purchase materials, hire service providers, etc.

Platform 203 further includes ratings 305, wherein subcontractors, general contractors, service providers, etc. can be rated, thereby providing additional information on all relevant parties.

In addition, platform 203 can provide options 309 associated with an auction 307, the options can include, among others, the ability to extend the auction if a target price is not met, the ability to limit the auction to specific parties, such as prior subcontractors that the general contractor is familiar with e.g. a sealed auction, or any other option.

Further, platform 203 includes a notice function 311, wherein notices can be sent to subcontractors, such as deadline reminders 313, the deadline reminders being for a bid, reminders for a completion time, payments, document creation, etc. In addition, notices can be sent to other parties, such as the general contractor, when a bid is placed, when work is completed, etc. This allows for immediate notification for updates.

In the preferred embodiment, it is contemplated that the platform 203 can receive payment 315 to access and use the platform, wherein general contractors pay a percentage of their profits and/or savings to a platform management company, thereby providing a means for the platform management company to profit. Additionally, the use of site specific vouches, tokens or the like could be used to facilitate the bidding.

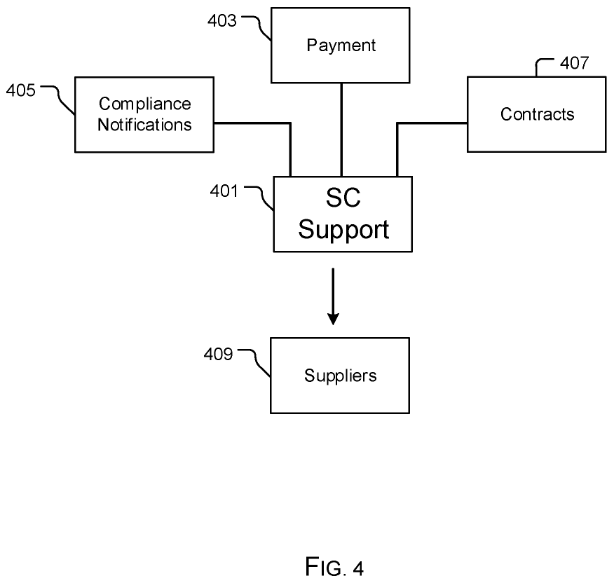

In FIG. 4, a diagram depicts features associated with a subcontractor portal 401, wherein the subcontractor can receive needed support such as the ability to make and receive payments 403. In addition, the subcontractor can receive necessary compliance notifications 405. In the preferred embodiment, one or more contracts 407 can be automatically created and pre-populated upon the hiring of a subcontractor, the one or more contracts 407 can include the details of the job, such as pricing, dates, materials, parties, etc. It should be appreciated that the contracts can be formed to be electronically signed/acknowledged by the parties, thereby providing for a convenient means to secure the agreements.

Further, it should be appreciated that communication with suppliers 409 can be facilitated through the subcontractor portal 401, thereby again increasing the efficiency associated with a construction project.

It should be appreciated that one of the unique features believed characteristic of the present application is the creation of a platform that can be used for reverse auctioning of construction jobs, and wherein the platform includes additional features, such as the creation of a contract, to streamline and increase efficiency of construction projects.

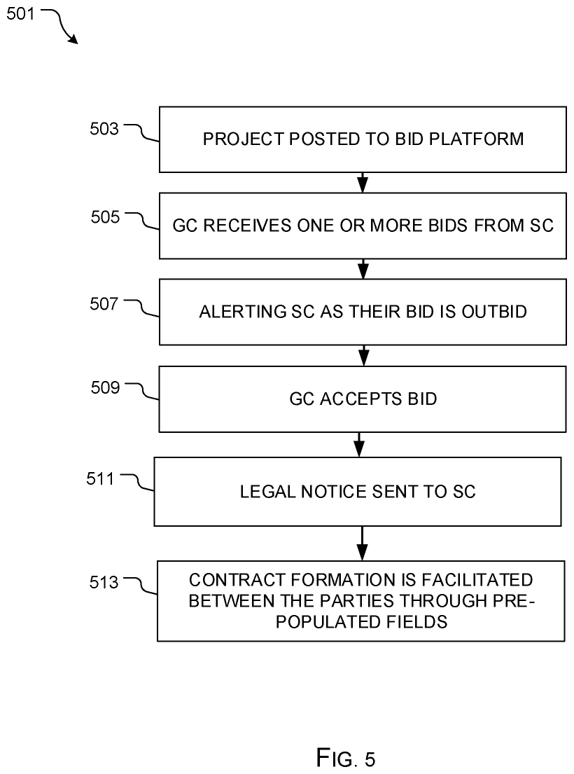

In FIG. 5, a flowchart 501 depicts the method of system 201. During use, after the GC is responsible for a project and posts all relevant details of the project to the bid platform, one or more SCs can bid on the project, as shown with boxes 503, 505. The SCs can receive notifications that they have been outbid, thereby providing the needed information to drive the cost down, as shown with box 507. Once the GC accepts one of the bids, legal notice is sent to the winning SC, and one or more contracts can be created between the parties, thereby providing for security relating to the agreement, as shown with boxes 509, 511, 513.

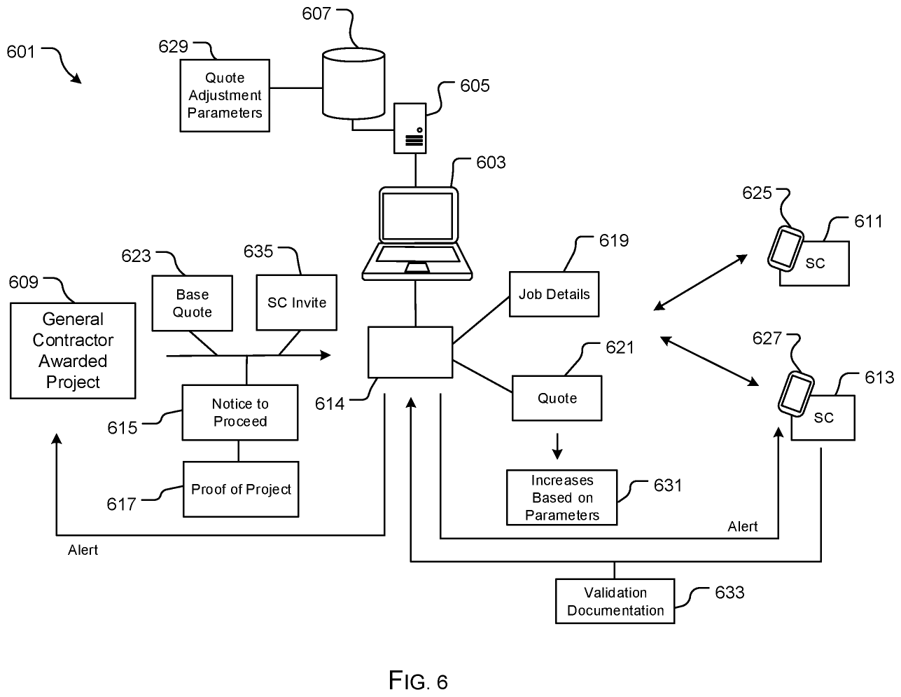

In FIG. 6, a simplified schematic depicts a construction project management system 601 in accordance with an alternative embodiment of the present application. System 601 can include some or all of the features and functionality discussed above in connection with system 201. In this embodiment, system 601 includes one or more of a computing device 603, server 605, and database 607 configured to receive, process, and store data associated with system 601. It should be appreciated that these components can be in wireless or wired communication, and further, these components could be incorporated into a single device or multiple devices.

An online platform 607 is configured to facilitate a connection and communication between a general contractor 609 and one or more subcontractors 611, 613, wherein the online platform 614 facilitates streamlined hiring and contract formation between the GC 609 and one or more SCs 611, 613. As shown, in this embodiment, the GC 609 has already been awarded a construction project from the project owner/manager or the like. This ensures efficiency associated with system 601.

During use, the GC 609 will provide a notice to proceed documentation 615 which functions as a proof of project 617. The notice to proceed documentation 615 ensures that the GC has been awarded the project, thereby ensuring that the SC's involved in the system are only attempting to win jobs from a GC that already has a project. The notice to proceed documentation 615 is known in the art, and is a legal documentation stating that the GC is notified to commence with work in accordance with an agreement and that the GC is to complete the work within a predetermined time period. The documentation 615 can include any number of details, such as the date of being awarded the project, a date of commencement of the project, a property address, a project number, a project description, ownership details of the project, or other details.

System 601 is configured to receive the notice to proceed documentation 615 via online platform 614, wherein a validation procedure is achieved. The validation procedure can be achieved via processing of the notice to proceed documentation 615 in any number of ways, such as through one or more algorithms or through personnel configured to validate the documentation to ensure the GC has been awarded the project.

It should be appreciated that one of the unique features believed characteristic of the present invention is the validation of the notice to proceed, thereby ensuring efficiency of the system.

System 601 is configured to receive project details and provide job details 619 associated with subcontracting jobs. The job details 619 can vary based on the project and the need as determined by the GC. System 601 can proceed with an auction format, as previously discussed, wherein the one or more SCs will bid on a job to drive the price down. Alternatively, as shown herein, system 601 can include a quote 621, which starts with a base quote 623 as determined by the GC. The base quote 623 represents a starting price that the GC wants to pay for work. This is transmitted through the online platform 614 to the one or more SCs, wherein the SCs will receive the quote and details through computing devices 625, 627.

One of the one or more SCs can accept the base quote 623 via the online platform 614. An acceptance of the base quote 623 will create a contract between the SC and the GC for the job. Alternatively, should no SC accept the base quote 623, the GC can establish quote adjustment parameters 629 to be implemented and processed via one or more machines and the online platform 614. The quote adjustment parameters will establish a means for the quote 621 to increase 631. One contemplated set of parameters is a dollar or percent value over a time period value, thereby increasing the quote by the dollar value as each time period passes. This allows for the quote to increase until the price is acceptable for one of the SCs, as which point the SC can automatically accept the quote, or can choose to accept the quote, thereby creating a contract between the GC and the SC.

Another unique feature believed characteristic of the present application is the use of an increasing quote to achieve a price point that is suitable for one of the SCs. This method ensures that the GC will pay as low of an acceptable price as possible. It should be appreciated that the system can function smoothly, wherein SCs can set their price through the platform, thereby allowing for the quote to be accepted automatically when the quote hits their price.

The system can be configured to transmit one or more alerts to the GC and SCs, such alerts can indicate that a quote has been accepted, that the quote has increased, that a contract has been formed, or any other alert.

In some embodiments, the online platform 614 can be configured to receive validation documentation 633 associated with the SCs. This documentation can be any contract, form, license, or other documentation that proves the SC is suitable for a specific job. In addition, it is contemplated that the GC can specifically invite 635 one or more SCs, thereby providing the GC with control over SCs that will be accepting the work.

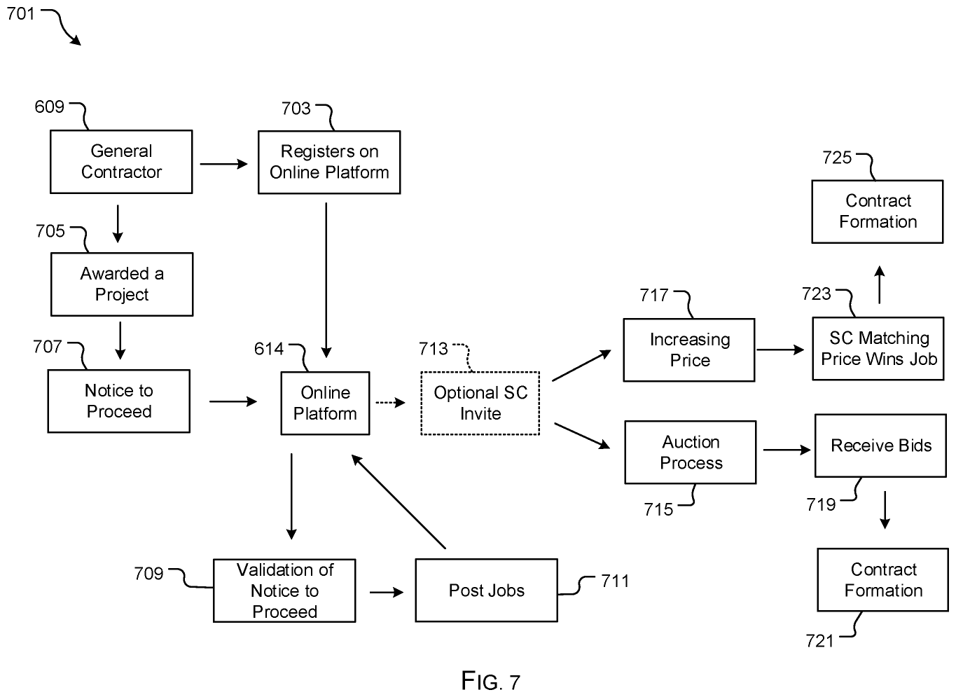

In FIG. 7, a flowchart 701 depicts a method associated with the GC 609 for clarity. The GC registers on the online platform 703, which can include a procedure of providing contact information, company information, licenses, work history, or any other details. The GC works with a project owner or manager to receive a project 705. Based on the GC being awarded a project, the GC will receive a notice to proceed 707 which can then be uploaded/otherwise provided to the online platform 614, wherein the platform 614 validates the notice to proceed 709. After validation of the notice to proceed, the GC can post one or more jobs 711 to the online platform. The GC can optionally invite 713 one or more SCs to the job and can select for the job to be processed through an auction 715 or a price increase structure 717. Through the auction process, one or more SCs can bid 719 on the job for a predetermined amount of time, thereby forcing the price down until a contract 721 is formed between the winning SC and the GC. Through the price increase process, the price will increase until matching with a SC price 723 at which point a contract 725 is formed between the parties.

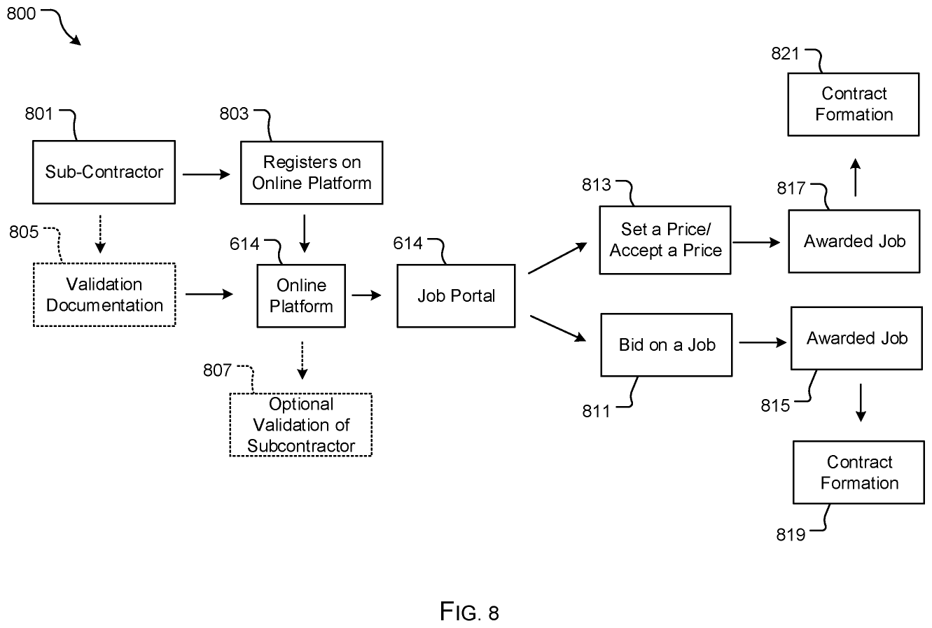

In FIG. 8, a flowchart 800 depicts a method associated with the SC 801. The SC will register on the online platform 803 and can optionally provide validation documentation 805 to be validated 807 through the online platform 614. The SC will have access to a job portal 809 through which jobs from the GC are presented in one of the two formats. Depending on the format, the SC will either have the opportunity to bid 811 or set/accept a price 813. Once the SC is awarded the job 815, 817, a contract 819, 821 will be formed between the parties.

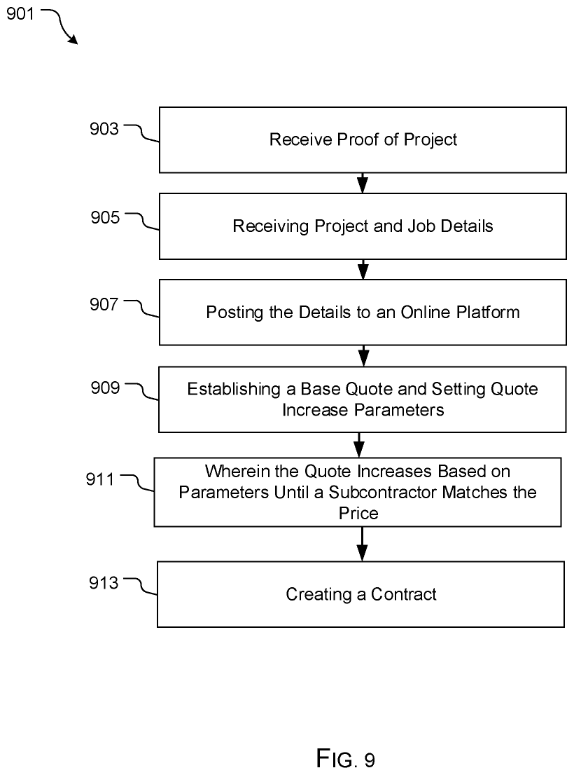

In FIG. 9, another flowchart 901 depicts a method associated with system 601. The platform is configured to receive the proof of project and validate the proof of project, as shown with box 903. The platform will receive project and job details from the GC to post jobs on the online platform, as shown with boxes 905, 907. The GC can either elect for a standard bidding process, as described above, or can establish a base quote and quote adjustment parameters, as shown with box 909. The platform, along with necessary computing devices, will be configured to increase the quote based on the parameters until matching a subcontractor's price, or being accepted by a subcontractor, as shown with box 911. Once the job is awarded to a subcontractor, a contract is formed, as shown with box 913.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A construction project management method, comprising:
receiving a proof of project document associated with a project for a general contractor, the proof of project document having one or more details of the project contained therein and being verification of the general contractor having been awarded the project;
receiving a plurality of details about the project from the general contractor;
posting the plurality of details about the project to an online platform accessible by a plurality of subcontractors each having a computing device;
receiving a base quote for a job associated with the project, the base quote being determined by the general contractor and the base quote being a lowest price the general contractor is willing to pay for completion of the job;
posting the base quote for the job on the online platform for acceptance by one of the subcontractors; and
creating a contract associated with the job between the general contractor and one or more subcontractors.

2. The method of claim 1, further comprising:
inviting one or more selected subcontractors to a private portal of the online platform to provide exclusive access to the job, the one or more selected subcontractors being selected by the general contractor.

3. The method of claim 1, further comprising:
establishing one or more parameters to be processed by a processor to increase the base quote according to the one or more parameters.

4. The method of claim 3, wherein the one or more parameters are a time parameter and a dollar value parameter, wherein the base quote increases by the dollar value parameter at every increment of the time parameter.

5. The method of claim 1, further comprising:
receiving validation documentation from the plurality of subcontractors, thereby validating one or more credentials of each of the plurality of subcontractors.

6. The method of claim 5, wherein the validation documentation comprises one or more of:
insurance documents;
a license;
a company identifying documentation; and
a contact information documentation.

7. The method of claim 1, further comprising:
notifying the general contractor and the plurality of subcontractors when the base quote is accepted by one of the plurality of subcontractors, the notifying being achieved via mobile computing devices.

8. The method of claim 1, further comprising:
connecting the general contractor to one or more of the plurality of subcontractors through the online platform.

9. The method of claim 1, further comprising:
creating a work order associated with the job based on the plurality of details of the project.
